(19) United States
(12) Patent Application Publication
(10) Pub. No.: US 2023/0177460 A1
(43) Pub. Date: Jun. 8, 2023

(54) METHOD AND SYSTEM FOR AUTOMATED OPTIMIZATION OF DELIVERY OF PRODUCTS TO MULTIPLE USERS ON A DIGITAL PLATFORM

(71) Applicant: FLIPKART INTERNET PRIVATE LIMITED, Bengaluru (IN)

(72) Inventors: Sai Karthik Vuppalapati, Vijayawade (IN); Sumit Jindal, Sirsa (IN); Shailendra Kumar, Bangalore (IN); Sanjay Kukreja, Bangalore (IN); Sandilya Konduri, Bangalore (IN)

(73) Assignee: FLIPKART INTERNET PRIVATE LIMITED, Bengaluru (IN)

(21) Appl. No.: 18/075,866

(22) Filed: Dec. 6, 2022

(30) Foreign Application Priority Data
Dec. 7, 2021 (IN) 202141056780

(51) Int. Cl. G06Q 10/08; G06Q 10/04

(52) U.S. Cl. CPC G06Q 10/087; G06Q 10/047

(57) ABSTRACT

The present disclosure relates to a method and system for automated optimization of delivery of products to users on a digital platform. Said method comprising: (1) fetching, by a processing unit [102], a location data of the multiple users of the digital platform and a hub location data of one or more hubs of the digital platform, from a memory unit [104]; (2) generating, by a pixel generator [106], a set of one or more geographic pixels from the location data of the multiple users; (3) determining, by the processing unit [102], a set of distance parameters (4) mapping, by a mapping unit [108], the set of one or more geographic pixels with the one or more hubs and (5) determining, by the mapping unit [108], an optimized hub for each subset of geographic pixels.

### RELATED APPLICATION

This application claims priority under 35 U.S.C. § 119 to Indian Patent Application No. 202141056780, filed on Dec. 7, 2021, the entire contents of which are incorporated herein by reference

### FIELD OF THE DISCLOSURE

The present disclosure relates generally to the field of supply chain management. More particularly, the disclosure relates to methods and systems for automated optimization of delivery of products to users.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

With an increasing number of users on the e-commerce platforms, and the amount of orders being placed everyday, an effective planning and management of delivery of products is necessary, especially for cost effective logistic management. For a small number of deliverables, the delivery cost is not much of a concern but as the number of orders increases, this becomes especially significant. Thus, an effective management and optimization of delivery of products is needed for saving money, time, and fuel.

The last mile network of an ecommerce platform is extremely significant part of the supply chain as it is directly connected to the users. Also, it is the most expensive one as well, since it requires the maximum amount of manpower and resources. Therefore, it is imperative to optimize the serviceable areas of the last mile delivery hubs. This not only saves time, costs, and fuel, but also contributes to a better user experience as the products are delivered on time to the customers.

One way of doing this is seen as manually optimizing the serviceable areas of the last mile delivery hubs. However, this is possible only for small number of products at only select locations, but not for large number of products to be delivered across a large geographic area.

Further, this involves huge manpower to design the optimised routes for delivery of products. Additionally, the manual design of routes is not efficient as it is difficult to consider the dynamic demand of users at various locations.

Thus, there exists an imperative need in the art to provide a system and method for automated optimization of delivery of products. This will help saving money, time, and fuel, and will also contribute to better customer experience.

### SUMMARY

This section is intended to introduce certain objects and aspects of the disclosed method and system in a simplified form and is not intended to identify the key advantages or features of the present disclosure.

One aspect of the present disclosure relates to a system for automated optimization of delivery of products to users on a digital platform. Said system comprises a processing unit configured to fetch a location data of the multiple users of the digital platform and a hub location data of one or more hubs of the digital platform, from a memory unit. Further, a pixel generator is configured to generate a set of one or more geographic pixels from the location data of the multiple users, wherein each geographic pixel of the set of one or more geographic pixels is associated with a pixel location information, and wherein each geographic pixel of the set of one or more geographic pixels comprises a location data of one or more users from the location data of the multiple users of the digital platform. Then, the processing unit determines a set of distance parameters based on the pixel location information of each geographic pixel of the set of one or more geographic pixels and the hub location data of the one or more hubs. Further, a mapping unit maps the set of one or more geographic pixels with the one or more hubs based at least on the set of distance parameters. The mapping further comprises generating one or more subsets of geographic pixels of the set of one or more geographic pixels, wherein each subset of geographic pixels is mapped to one corresponding target hub from the one or more hubs, and a load parameter of each subset of geographic pixels is less than a load parameter of the corresponding target hub. Finally, the mapping unit is configured to determine an optimized hub for each subset of geographic pixels based on the mapping of the set of geographic pixels with the one or more hubs, wherein a distance between the optimized hub and the corresponding subset of geographic pixel is a minimum possible distance.

Another aspect of the present disclosure relates to a method for automated optimization of delivery of products to multiple users on a digital platform, the method comprising: (1) fetching, by a processing unit, a location data of the multiple users of the digital platform and a hub location data of one or more hubs of the digital platform, from a memory unit; (2) generating, by a pixel generator, a set of one or more geographic pixels from the location data of the multiple users, wherein each geographic pixel of the set of one or more geographic pixels is associated with a pixel location information, and wherein each geographic pixel of the set of one or more geographic pixels comprises a location data of one or more users from the location data of the multiple users of the digital platform; (3) determining, by the processing unit, a set of distance parameters based on the pixel location information of each geographic pixel of the set of one or more geographic pixels and the hub location data of the one or more hubs; (4) mapping, by a mapping unit, the set of one or more geographic pixels with the one or more hubs based at least on the set of distance parameters, the mapping further comprising generating one or more subsets of geographic pixels of the set of one or more geographic pixels, wherein (a) each subset of geographic pixels is mapped to one corresponding target hub from the one or more hubs, and (b) a load parameter of each subset of geographic pixels is less than a load parameter of the corresponding target hub; and (5) determining, by the mapping unit, an optimized hub for each subset of geographic pixels based on the mapping of the set of geographic pixels with the one or more hubs, wherein a distance between the optimized hub and the corresponding subset of geographic pixel is a minimum possible distance.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings.

Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an architecture of a system for automated optimization of delivery of products to users on a digital platform, in accordance with exemplary embodiments of the present disclosure.

FIG. 2 illustrates an exemplary method flow diagram depicting a method for automated optimization of delivery of products to multiple users on a digital platform, in accordance with exemplary embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processor” or “processing unit” includes processing unit, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure.

As used herein, a “hub” or “logistics hub” refers to a center or specific area designated to deal with activities related to transportation, organization, sorting, dispatch, coordination and distribution of products for local distribution. A major function of a hub is to streamline the dispatch and shipment of products to the end customer. The hub may also be construed as a warehouse of products where the products are kept or stored for distribution to the customers as and when a customer or a user places an order of the product on a digital platform. Also, a hub may be construed as a place where a seller or a vendor sends its products for delivery to a customer or a user who places an order of the product on a digital platform. A hub covers an area of service or a boundary within which it provides the delivery service to the end customers or users.

In a known solution, the delivery services of products as a part of ecommerce supply chain are based on a list of pin codes it is going to serve. In this, the pin code allocation to the hub is done manually based on the estimated demand and size of the hub. Further, the area of service of a hub can also be defined using a geofence boundary that is manually identified.

However, a major drawback of this approach is that the pincode dependent serviceability does not serve all the customers by their respective nearest hub. In this known art, there is no hard boundary of a pin code area and there is always an overlap with boundaries of other pin codes. Also, the different pin codes are not of uniform size or shape. Due to pincode dependent serviceability, not all customers are served by their nearest hub or the optimal hub. This in many cases, increases the distance travelled to deliver shipments and leads to increased delivery costs, time, and fuel. Further, the manual geofence boundary creation does not necessarily provide the most optimal boundary. This also increases the distance travelled to deliver shipments leading to increased delivery costs and unnecessary wastage of fuel and other resources. Also, there is an overlap between boundaries of multiple hubs which leads to inefficient decision making regarding the dispatch and shipment of products, leading to increased logistics costs and time.

Hereinafter, exemplary embodiments of the present disclosure will be described in detail with reference to the accompanying drawings so that those skilled in the art can easily carry out the solution provided by the present disclosure.

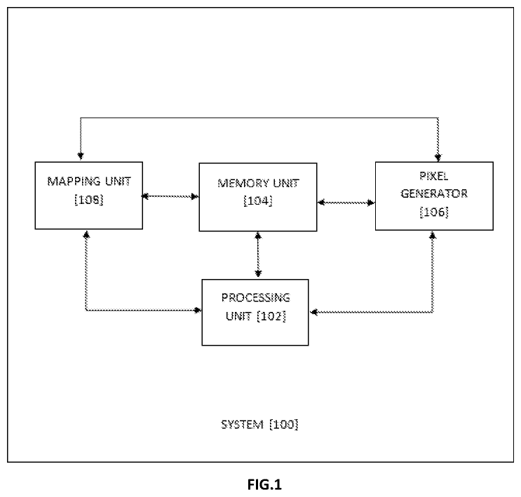

FIG. 1 illustrates an architecture of a system for automated optimization of delivery of products to users on a digital platform. As shown, the system [100] comprises a processing unit [102], a memory unit [104], a pixel generator [106], and a mapping unit [108].

The processing unit [102] is configured to fetch a location data of the multiple users of the digital platform. This location data of the users includes a delivery address information, a pin code information, and a latitude/longitude information related to a delivery address to information. Further, the location data of the multiple users can be a location data of the users who have provided to and/or stored their location information on the digital platform previously while placing an order or setting up a user account on the digital platform. Also, the location data of the multiple users is a dynamic data as the users can add, delete or modify their accounts and modify their location information stored on the digital platform. In an exemplary implementation, along with the location data of the users on the digital platform, other data of the users may also be fetched by the processing unit [102]. This other data of the users may include user order history, frequency of the users visiting and/or placing orders on the digital platform. Further, the processing unit [102] also fetches a hub location data of one or more hubs for providing logistic services. This hub location data comprises a latitude and longitude information of the location of the hub. Also, the hub location data can be a dynamic pre-stored data, meaning that it can be updated periodically to add new hubs or delete existing hubs. Further, in an exemplary implementation, along with the hub location data of the hubs, other data of the hubs may also be fetched by the processing unit [102]. This other data of the hubs includes a hub capacity information, a boundary information, a pixel information, a hub load information related to the one or more hubs. Here, the ‘hub capacity information’ or the ‘load capacity of a hub’ refers to the maximum number of orders it can handle for providing delivery services in a given time; the ‘boundary information’ refers to area of service covered by a hub or a boundary within which it provides the delivery service to the end customers or users; the ‘pixel information’ is all the information of the geographic pixels mapped to a particular hub such as the sum of all pixel loads mapped to a hub, number of geographic pixels being served by a hub, location information of the geographic pixels being served by a hub, etc.; the ‘hub load information’ refers to the actual load or the number of orders being served by a hub. All the information as discussed above, is fetched by the processing unit [102] from a memory unit [104] that is operably coupled with the processing unit [102].

Further, the pixel generator [106] is configured to generate a set of one or more geographic pixels from the location data of the multiple users. These geographic pixels are of uniform size and/or shape. In an implementation, the shape of the geographic pixels is rectangular. In a preferred implementation, the shape of the geographic pixels is square. In another implementation, for example, the latitudinal distance covered by the geographic pixel on ground is corresponding to a 0.005 radian units change in the latitude and longitudinal distance covered by the geographic pixel on ground is also corresponding to a 0.005 radian units change in the longitude. Thus, in this implementation, the area covered on ground by one geographic pixel would be approximately 0.3 km². A person skilled in the art would appreciate that this calculation of area from latitude and longitude is only exemplary and may also change with the location of measurement. Accordingly, it does not restrict the invention in any way or manner possible. Thus, a large area such as a city or town is divided into a large number of geographic pixels of uniform size and shape.

Each geographic pixel of the set of one or more geographic pixels comprises a location data of one or more users of the digital platform. Further, each geographic pixel is also associated with a pixel location information, a user density information and a load parameter. The user density information refers to the number of users, that is, the potential customers of the digital platform in the area of geographic pixel. This user density information may be estimated by the number of active accounts of users in the geographic pixel. The more the user density is in a particular geographic pixel, the larger is the pixel load or the load parameter. Pixel load or load parameter refers to the amount or the number of orders placed by users in the geographic pixel during a time period.

Further, the processing unit [102] determines a set of distance parameters based on a distance between the pixel location of each geographic pixel of the set of one or more geographic pixels and the hub location data of the one or more hubs. In an implementation, the set of distance parameters comprises the distance between the pixel location of each geographic pixel of the set of one or more geographic pixels and the location of each hub of the one or more hubs. In an implementation, a set of distances can be calculated between each geographic pixel and the hubs as a haversine distance function. In another implementation, set of distances can be calculated between each geographic pixel and the hubs as a Euclidean distance function. A person skilled in the art would appreciate that the distance parameters can also be determined using some other suitable functions and the haversine distance function or the Euclidean distance function are exemplary implementations only. Accordingly, they do not restrict the invention in any possible manner.

Further, the mapping unit [108] maps the set of one or more geographic pixels with the one or more hubs based at least on the set of distance parameters. The mapping further comprises generating one or more subsets of geographic pixels of the set of one or more geographic pixels. The subset of geographic pixels is referred to as a group of geographic pixels that are mapped to one target hub. This target hub is selected based on various parameters to optimize the overall distance to be travelled for the delivery of a product to the end user. The parameters to select a target hub for a geographic pixel can be the hub capacity, location information of the hub comprising the latitude and longitude information of the hub, load parameter of the geographic pixel, etc. Further, a subset of geographic pixels can be mapped to only one and at least one hub. This ensures that each geographic pixel is mapped to one hub and not more than one hub. The orders placed by the users in a geographic pixel will be served by the particular hub mapped to that geographic pixel. Also, each subset of geographic pixels is mapped to one corresponding target hub from the one or more hubs in a way that the load parameter of each subset of geographic pixels is less than a load parameter of the corresponding target hub, meaning that, the sum of pixel loads of all geographic pixels in the subset of geographic pixels cannot be greater that the load capacity of the corresponding target hub to which the subset is mapped. Here, the load capacity of a hub refers to the number of orders it can handle for providing delivery services.

Finally, the mapping unit [108] is configured to determine an optimized hub for each subset of geographic pixels based on the mapping of the set of geographic pixels with the one or more hubs, wherein a distance between the optimized hub and the corresponding subset of geographic pixel is a minimum possible distance. For clarification purposes, it must be noted that the mapping unit [108] is configured to determine an optimized hub for each subset of geographic pixels, also means that the mapping unit [108] is configured to determine an optimized subset of geographic pixels for every hub.

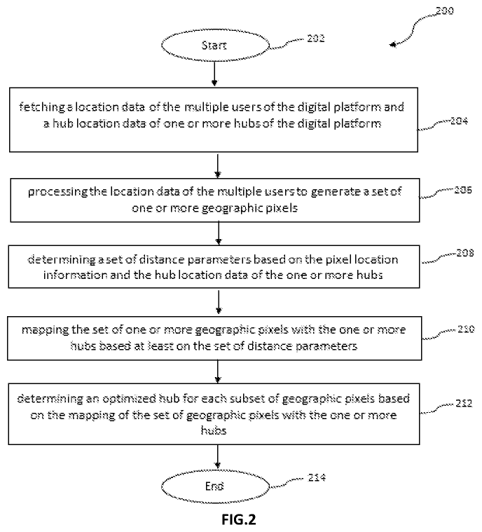

Referring to FIG. 2, an exemplary method flow diagram depicting a method for automated optimization of delivery of products to multiple users on a digital platform is shown. The method starts at step 202 and goes to step 204. At step 204, the processing unit [102] fetches a location data of the multiple users of the digital platform. This location data of the users includes a delivery address information, a pin code information, and a latitude/longitude information related to a delivery address information. Further, the location data of the multiple users can be a location data of the users who have provided to and/or stored their location information on the digital platform previously while placing an order or setting up a user account on the digital platform. Also, the location data of the multiple users is a dynamic data as the users can add, delete or modify their accounts and modify their location information stored on the digital platform. In an exemplary implementation, along with the location data of the users on the digital platform, other data of the users may also be fetched by the processing unit [102]. This other data of the users may include user order history, frequency of the users visiting and/or placing orders on the digital platform. Further, the processing unit [102] also fetches a hub location data of one or more hubs for providing logistic services. This hub location data comprises a latitude and longitude information of the location of the hub. Also, the hub location data can be a dynamic pre-stored data, meaning that it can be updated periodically to add new hubs or delete existing hubs. Further, in an exemplary implementation, along with the hub location data of the hubs, other data of the hubs may also be fetched by the processing unit [102]. This other data of the hubs includes a hub capacity information, a boundary information, a pixel information, a hub load information related to the one or more hubs. Here, the ‘hub capacity information’ or the ‘load capacity of a hub’ refers to the maximum number of orders it can handle for providing delivery services in a given time, the ‘boundary information’ refers to area of service covered by a hub or a boundary within which it provides the delivery service to the end customers or users, the ‘pixel information’ is all the information of the geographic pixels mapped to a particular hub such as the sum of all pixel loads mapped to a hub, number of geographic pixels being served by a hub, location information of the geographic pixels being served by a hub, etc., the ‘hub load information’ refers to the actual load or the number of orders being served by a hub. All the information as discussed above, is fetched by the processing unit from a memory unit [104] that is operably coupled with the processing unit [102].

For example, the data fetched from the memory unit [104] by the processing unit [102] in step 204 comprises delivery address of a user containing a pin code. Along with this, the information also includes the latitude and longitude information related to the above delivery address. Now the whole geographic area, say, a city or town, is divided into a large number of geographic pixels. Say, a geographic pixel has the latitude and longitude extending from (13.725, 77.345) to (13.730, 77.350) radian units. This covers an area of around 0.3 km² on ground near the equator. Further, the data also comprises a hub location data, which contains at least the latitude and longitude information of the hub location. Also, the other data of the hubs is also fetched by the processing unit [102] from the memory unit [104]. This comprises hub capacity, hub identification name or number, etc. Say, in this example, the hub capacity (Lᵢ) of a Hub 1 is 50 units and that of Hub 2 is 40 units.

At step 206, the pixel generator [106] generates a set of one or more geographic pixels from processes the location data of the multiple users. These geographic pixels are of uniform size and/or shape. In an implementation, the shape of the geographic pixels is rectangular. In a preferred implementation, the shape of the geographic pixels is square. In another implementation, the latitudinal distance covered by the geographic pixel on ground is corresponding to a 0.005 radian units change in the latitude and longitudinal distance covered by the geographic pixel on ground is also corresponding to a 0.005 radian units change in the longitude. Thus, in this implementation, the area covered on ground by one geographic pixel would be approximately 0.3 km². A person skilled in the art would appreciate that this calculation of area from latitude and longitude is only exemplary and may also change with the location of measurement. Accordingly, it does not restrict the invention in any way or manner possible. Thus, a large area such as a city or town is divided into a large number of geographic pixels of uniform size and shape.

Each geographic pixel of the set of one or more geographic pixels comprises a location data of one or more users of the digital platform. Further, each geographic pixel is also associated with a pixel location information, a user density information and a load parameter. The user density information refers to the number of users, that is, the potential customers of the digital platform in the area of geographic pixel. This user density information may be estimated by the number of active accounts of users in the geographic pixel. The more the user density is in a particular geographic pixel, the larger is the pixel load or the load parameter. Pixel load or load parameter refers to the amount or the number of orders placed by users in the geographic pixel during a time period.

Thus, continuing with the above example, in step 206, the pixel generator [106] uses the data of multiple users fetched by the processing unit [102] in step 204 to determine all the delivery addresses that fall in this area of the geographic pixel (13.725, 77.345) to (13.730, 77.350) radian units. Similarly, the latitude and longitude information of all geographic pixels in the whole city or town are determined by the pixel generator [106]. Now, say, the pixel load (wᵢ) is allocated to various geographic pixels as given below:

| | pixel_load |
|---|---|
| pixel_id | (wᵢ) |
| 1 | 10 |
| 2 | 20 |
| 3 | 35 |
| 4 | 15 |

At step 208, the processing unit [102] determines a set of distance parameters based on the pixel location of each geographic pixel of the set of one or more geographic pixels and the hub location data of the one or more hubs. In an implementation, the set of distance parameters comprises the distance between the pixel location of each geographic pixel of the set of one or more geographic pixels and the location of each hub of the one or more hubs. In an implementation, a set of distances can be calculated between the pixel location of each geographic pixel of the set of one or more geographic pixels and the hubs as a haversine distance function. In another implementation, the set of distances can be calculated between the pixel location of each geographic pixel of the set of one or more geographic pixels and the hubs as a Euclidean distance function A person skilled in the art would appreciate that the distance parameters can also be determined using some other suitable functions and the haversine distance function or the Euclidean distance function are exemplary implementations only. Accordingly, they do not restrict the invention in any possible manner.

Continuing with the above example, the distance parameters (dᵢⱼ) can be a matrix determining a parameter based on the distance of each geographic pixel from each hub. Therefore, the value of dᵢⱼ determines how far is a geographic pixel “i” located from a hub “j”. Say, for example, “i” denotes a geographic pixel and “j” denotes a hub. For various exemplary values of “i” and “j”, the exemplary values of dᵢⱼ are given below:

| dᵢⱼ | j = 1 | j = 2 | j = 3 |
|---|---|---|---|
| i = 1 | 500 | 1200 | 1800 |
| i = 2 | 1500 | 2000 | 2300 |
| i = 3 | 700 | 1000 | 2200 |

At step 210, the mapping unit [108] maps the set of one or more geographic pixels with the one or more hubs based at least on the set of distance parameters. The mapping further comprises generating one or more subsets of geographic pixels of the set of one or more geographic pixels. The subset of geographic pixels is referred to as a group of geographic pixels that are mapped to one target hub. This target hub is selected based on various parameters to optimize the overall distance to be travelled for the delivery of a product to the end user. The parameters to select a target hub for a geographic pixel can be the hub capacity, location information of the hub comprising the latitude and longitude information of the hub, load parameter of the geographic pixel, etc. Further, a subset of geographic pixels can be mapped to one hub only. In the above example, this is ensured using a binary variable—“allocation variable, aᵢⱼ” that each geographic pixel is mapped to at least one hub and not more than one hub. The value of aᵢⱼ is either 0 or 1. Value of aᵢⱼ=0 means that a geographic pixel “i” is not mapped to a hub “j”; and value of aᵢⱼ=1 means that a geographic pixel “i” is mapped to a hub “j”. This uses the following constraint functions:

$$0 \leq {a}_{ij} \leq 1 ( allocation varible will be either 0 or 1 )$$

$${\sum }_{i} {a}_{ij} = 1 ( one pixel should be assigned to one hub only )$$

Thus, the orders placed by the users in a geographic pixel will be served by the particular hub mapped to that geographic pixel. Also, each subset of geographic pixels is mapped to one corresponding target hub from the one or more hubs in a way that the load parameter of each subset of geographic pixels is less than a load parameter of the corresponding target hub, meaning that, the sum of pixel loads of all geographic pixels in the subset of geographic pixels (Σᵢ wᵢⱼ*aᵢⱼ) cannot be greater that the load capacity (Lₐ) of the corresponding target hub to which the subset is mapped. Here, the load capacity of a hub refers to the number of orders it can handle for providing delivery services. Thus, the mapping unit [108] uses the following constraint function:

$${\sum }_{i} {w}_{ij} * {a}_{ij} \leq {L}_{j} ( total load allocated to a hub should be less than its capacity )$$

Finally, at step 212, the mapping unit [108] determines an optimized hub for each subset of geographic pixels based on the mapping of the set of geographic pixels with the one or more hubs, wherein a distance between the optimized hub and the corresponding subset of geographic pixel, that is, the stem distance, is a minimum possible distance. This determination is performed considering the above constraint functions. Thus, the mapping unit [108] uses the following functions for this purpose:

$$min . {\sum }_{i} {\sum }_{j} {d}_{ij} * {w}_{ij} * {a}_{ij} ( minimize the total stem distance )$$

Variables:

i—corresponds to pixels

j—corresponds to hubs

aᵢⱼ—allocation variable

wᵢ—pixel weight (load)

Lⱼ—Hub load capacities

dᵢⱼ—distance parameter

Constraints:

$$0 \leq {a}_{ij} \leq 1 ( allocation varible will be either 0 or 1 )$$

$${\sum }_{j} {a}_{ij} = 1 ( one pixel should be assigned to one hub only )$$

$${\sum }_{i} {w}_{ij} * {a}_{ij} \leq {L}_{j} ( total load allocated to a hub should be less than its capacity )$$

Following the above example, assuming that geographic pixel 1 is mapped to Hub 1, i.e., the value of a₁₁ is 1. Now, to ensure that geographic pixel 1 is mapped to Hub 1 only, the system [100] ensures that:

a₁₁+a₁₂+a₁₃+ . . . =1,

1+0+0+ . . . =1
that is, in the above example,

Also, to ensure that the sum of pixel loads of the geographic pixels mapped to a particular hub, the system [100] ensures that:

w₁*a₁₁+w₂*a₂₁+w₃*a₃₁+ . . . ≤L₁

10*1+20*0+35*0+≤50
that is, in the above example,

In order to allocate another geographic pixel “i” to Hub 1, the mapping unit [108] ensures that it necessarily satisfies this above equation, but that is not a sufficient condition. Thus, using the above constraints and functions, the mapping unit [108] determines the optimized stem distance in order to optimize the serviceable area of each hub. Thus, in this way, the mapping unit [108] determines an optimized hub for each subset of geographic pixels based on the mapping of the set of geographic pixels with the one or more hubs, wherein the distance between the optimized hub and the corresponding subset of geographic pixel is a minimum possible distance or the stem distance. For clarification purposes, it must be noted that the mapping unit [108] is configured to determine an optimized hub for each subset of geographic pixels, also means that the mapping unit [108] is configured to determine an optimized subset of geographic pixels for every hub.

Thus, by practicing and implementing the method and system as illustrated in the above discussion, a person skilled in the art would be able to reduce the stem distance and optimize the serviceable area of each hub. Further, this would reduce significant overlap in existing hub boundaries which can cause problems in identifying the hub owner for a given region. Since the last mile connectivity services are the most expensive one, requiring the maximum amount of manpower and resources, it was imperative to optimize the serviceable areas of the hubs, which is addressed by implementing and practicing the present disclosure. Thus, by optimizing the serviceable areas of the hubs, it not only saves time, costs, and fuel, but also contributes to a better user experience as the products are delivered on time to the customers. While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

We claim:

1. A method for automated optimization of delivery of products to multiple users on a digital platform, the method comprising:
fetching, by a processing unit [102], a location data of the multiple users of the digital platform and a hub location data of one or more hubs of the digital platform, from a memory unit [104];
generating, by a pixel generator [106], a set of one or more geographic pixels from the location data of the multiple users, wherein each geographic pixel of the set of one or more geographic pixels is associated with a pixel location information, and wherein each geographic pixel of the set of one or more geographic pixels comprises a location data of one or more users from the location data of the multiple users of the digital platform;
determining, by the processing unit [102], a set of distance parameters based on the pixel location information of each geographic pixel of the set of one or more geographic pixels and the hub location data of the one or more hubs;
mapping, by a mapping unit [108], the set of one or more geographic pixels with the one or more hubs based at least on the set of distance parameters, the mapping further comprising generating one or more subsets of geographic pixels of the set of one or more geographic pixels, wherein
each subset of geographic pixels is mapped to one corresponding target hub from the one or more hubs,
a load parameter of each subset of geographic pixels is less than a load parameter of the corresponding target hub; and
determining, by the mapping unit [108], an optimized hub for each subset of geographic pixels based on the mapping of the set of geographic pixels with the one or more hubs, wherein a distance between the optimized hub and the corresponding subset of geographic pixel is a minimum possible distance.

2. The method as claimed in claim 1, wherein the location data of the multiple users includes a delivery address information, a pin code information, and a latitude/longitude information related to a delivery address information of the multiple users on the digital platform.

3. The method as claimed in claim 1 wherein determining, by the processing unit [102], the set of distance parameters comprises determining a distance between the pixel location of each geographic pixel of the set of one or more geographic pixels and the location of each hub of the one or more hubs.

4. The method as claimed in claim 1 wherein the load parameter of each subset of geographic pixels is a sum of a load of each pixel in the subset of geographic pixels.

5. The method as claimed in claim 1, wherein each geographic pixel is further associated with a user density information and the load parameter.

6. The method as claimed in claim 5, wherein the mapping of the set of one or more geographic pixels with the one or more hubs is further based on the user density information of the one or more geographic pixels.

7. The method as claimed in claim 1, wherein each geographic pixel of the set of one or more geographic pixels is of uniform shape and size.

8. A system for automated optimization of delivery of products to users on a digital platform, the system comprising:
a processing unit [102] configured to:
fetch a location data of the multiple users of the digital platform and a hub location data of one or more hubs of the digital platform, from a memory unit;
a pixel generator [106] configured to:
process the location data of the multiple users to generate a set of one or more geographic pixels, wherein each geographic pixel of the set of one or more geographic pixels comprises a location data of one or more users from the location data of the multiple users of the digital platform;
the processing unit [102] further configured to:
determine a set of distance parameters based on the pixel location information of the set of one or more geographic pixels and the hub location data of the one or more hubs; and
a mapping unit [108] configured to:
map the set of one or more geographic pixels with the one or more hubs based at least on the set of distance parameters, the mapping further comprising generating one or more subsets of geographic pixels of the set of one or more geographic pixels, wherein
each subset of geographic pixels is mapped to one corresponding target hub from the one or more hubs,
a load parameter of each subset of geographic pixels is less than a load parameter of the corresponding target hub; and
determine an optimized hub for each subset of geographic pixels based on the mapping of the set of geographic pixels with the one or more hubs, wherein a distance between the optimized hub and the corresponding subset of geographic pixel is a minimum possible distance.

9. The system as claimed in claim 8, wherein the location data of the multiple users includes a delivery address information, a pin code information, and a latitude/longitude information related to a delivery address information of the multiple users on the digital platform.

10. The system as claimed in claim 8, wherein the processing unit [102] is configured to determine the set of distance parameters by determining a distance between the pixel location of each geographic pixel of the set of one or more geographic pixels and the location of each hub of the one or more hubs.

11. The system as claimed in claim 8, wherein the load parameter of each subset of geographic pixels is a sum of a load of each pixel in the subset of geographic pixels.

12. The system as claimed in claim 8, wherein each geographic pixel is further associated with a user density information and the load parameter.

13. The system as claimed in claim 12, wherein the mapping unit [108] is configured to map of the set of one or more geographic pixels with the one or more hubs further based on the user density information of the one or more geographic pixels.

14. The system as claimed in claim 8, wherein each geographic pixel of the set of one or more geographic pixels is of uniform shape and size.
